(19) United States
(12) Patent Application Publication
(10) Pub. No.: US 2015/0299479 A1
(43) Pub. Date: Oct. 22, 2015

(54) POLYURETHANE COATING COMPOSITION

(71) Applicant: Rohm and Haas Company, Philadephia, PA (US)

(72) Inventors: Zhenwen Fu, Norristown, PA (US); Andrew Swartz, Fleetwood, PA (US); Wenqin Wang, Phoenixville, PA (US)

(21) Appl. No.: 14/378,666

(22) PCT Filed: Feb. 15, 2013
(86) PCT No.: PCT/US13/26388

§ 371 Date: Aug. 14, 2014

Related U.S. Application Data
(60) Provisional application No. 61/600,257, filed on Feb. 17, 2012.

(51) Int. Cl. C09D 7/12; C09D 5/00; C09D 175/04

(52) U.S. Cl. CPC C09D 7/1291; C09D 175/04; C09D 5/00

(57) ABSTRACT

The present invention relates to a composition comprising a stable aqueous dispersion of polyurethane particles and pigment particles partially or fully encapsulated with a soft polymer. The composition of the present invention delivers relatively high gloss as well as gloss stability in coatings formulations.

### BACKGROUND OF THE INVENTION

The present invention relates to a stable aqueous dispersion of polyurethane particles and pigment particles partially or fully encapsulated with polymer.

The ability to obtain and control high gloss in latex-based pigmented coatings is highly desirable; nevertheless, the particulate nature of polymer binder tends to interfere with pigment distribution, causing agglomeration, thereby reducing initial gloss as well as gloss stability over time. Polyurethane latexes, which, in combination with acrylic latexes, offer a binder system for paints with highly desirable properties, as disclosed in U.S. 2009/0318596; however, polyurethane latex-based systems are especially prone to these agglomerative effects, which are especially pronounced for polyurethane latexes made by a pre-polymer followed by a diamine chain-extension process, due to the presence of residual amine or anionic groups, which are known to interact with pigment particles. Accordingly, it would be an advance in the art to discover a polyurethane-based latex binder system that had relatively high gloss and high gloss stability over time.

### SUMMARY OF THE INVENTION

The present invention addresses a need by providing a composition comprising a stable aqueous dispersion of polyurethane particles and pigment particles partially or fully encapsulated with a soft polymer having a T_{g} not higher than 35° C.; wherein the weight percent of the polyurethane particles is such that the range pigment volume concentration of the composition is in the range of 6 to 25.

The composition of the present invention addresses a need in the art by delivering relatively high gloss as well as gloss stability over time in coatings formulations.

### DETAILED DESCRIPTION OF THE INVENTION

The present invention provides a stable aqueous dispersion of polyurethane particles and pigment particles partially or fully encapsulated with a soft polymer having a T_{g} not higher than 35° C.; wherein the weight percent of the polyurethane particles is such that the range pigment volume concentration of the composition is in the range of 6 to 25. Preferably, the weight percent of polyurethane particles is from 10 weight percent, more preferably from 20 weight percent, to 70 weight percent, more preferably to 50 weight percent, and most preferably to 40 weight percent, based on the weight of the polyurethane particles and the soft polymer.

The soft polymer is preferably an acrylic, a styrene-acrylic, or a vinyl acrylic polymer. Preferably, the soft polymer includes structural units of styrene or a methacrylate such as methyl methacrylate or ethyl methacrylate; and an acrylate such as ethyl acrylate, butyl acrylate, 2-propylheptyl acrylate, or 2-ethylhexyl acrylate. As used herein, the term “structural unit” of the named monomer, refers to the remnant of the monomer after polymerization. For example, a structural unit of methyl methacrylate is as illustrated:

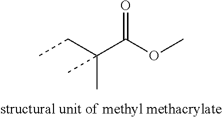

where the dotted lines represent the points of attachment of the structural unit to the polymer backbone.

The polyurethane dispersion is advantageously prepared by contacting under reaction conditions a diisocyanate with a diol, which is typically a polyether polyol, a polyester polyol, a polycaprolactone, or a polycarbonate or a combination thereof. The polyurethane may be thermoplastic and may also contain functionality such as pendant or endcapping hydroxyl, amine, or carboxylic acid groups, which can be cured with crosslinking agents such as polyaziridine, aminoplast resins, epoxies, water dispersible polyisocyanates, and multifunctional aldehydes including (cis, trans)-1,3-cyclohexanecarboxyaldehydes and (cis, trans)-1,4-cyclohexanecarboxyaldehydes. Examples of suitable commercially available polyurethane dispersions include Sancure 815 Polyurethane Dispersion and BayhydrolXP2557 Polyurethane Dispersion.

The pigment particles, preferably TiO₂ particles, are preferably fully encapsulated with the soft polymer having a shell thickness in the range of from 10 nm, more preferably from 30 nm, to 90 nm, more preferably to 70 nm.

Descriptions of partially polymer encapsulated polymers can be found, for example, in U.S. Pat. No. 5,509,960; U.S. Pat. No. 6,080,802; U.S. Pat. No. 6,214,467; U.S. Pat. No. 7,179,531; U.S. Pat. No. 7,081,488; and U.S. Pat. Pub. 2003/0018103A1. Examples of commercially available partially polymer encapsulated TiO₂ particles include EVOQUE™ Precomposite Polymers (A Trademark of The Dow Chemical Company or its Affiliates).

Examples of fully polymer encapsulated TiO₂ particles are described in U.S. Pat. No. 4,421,660; U.S. Pat. Pub. 2010/0298483, and EP1802662. A preferred general process for fully encapsulating TiO₂ particles in a polymer comprises the steps of a) forming a mixture of i) an aqueous dispersion of TiO₂ particles and an amphoteric polymer; ii) an anionic surfactant; and iii) sodium styrene sulfonate; b) adding to the mixture of step (a) a redox initiator system; then c) adding an aqueous dispersion of a first monomer; and d) polymerizing the first monomer to form an aqueous dispersion of a first polymer that encapsulates the TiO₂ particles.

The first monomer preferably comprises either a) a methacrylate monomer or a styrene monomer, or a combination thereof, and an acrylate monomer; or b) a methacrylate monomer, an acrylate monomer, and a vinyl acetate monomer; or c) a vinyl acetate monomer and an ethylene monomer. More preferably, the first monomer comprises a methacrylate or a styrene monomer, or a combination thereof, and an acrylate monomer.

It may be further desirable to include the following steps after step d): e) adding to the mixture an aqueous dispersion of a second monomer, which preferably comprises a methacrylate or a styrene monomer, or a combination thereof, and an acrylate monomer; and f) polymerizing the second monomer to form an aqueous dispersion of a second polymer that at least partially encapsulates the first polymer.

The first and/or second monomer may further include other polymerizable monomers such as hydroxyl functional acrylates and methacrylates including hydroxyethyl methacrylate and hydroxypropylate acrylate; carbamate functional acrylates and methacrylates including hydroxypropyl carbamate acrylate; carboxylic acid functional monomers including acrylic acid and methacrylic acid; and acrylamides including N-methylolacrylamide. These functionalized groups, when present in the encapsulating polymer, are capable of being crosslinked with crosslinking agents such as polyaziridine, aminoplast resins, epoxy resins, water dispersible polyisocyanates, and multifunctional aldehydes.

The amphoteric polymer, which adsorbs to the surface of the TiO₂ particles, is a polymeric dispersant for TiO₂ particles that contains amine functionality and acid functionality, preferably a polymer that is prepared from the copolymerization of an ethylenically unsaturated amine functional monomer and an ethylenically unsaturated sulfur-acid functional monomer. Examples of suitable ethylenically unsaturated amine functional monomers include dimethylaminoethyl methacrylate, dimethylaminoethyl acrylate, dimethylaminopropyl methacrylamide, dimethylaminopropyl acrylamide, t-butylaminoethyl methacrylate and t-butylaminoethyl methacrylate, with dimethylaminoethyl methacrylate (DMAEMA) being preferred. Examples of suitable ethylenically unsaturated sulfur-acid functional monomers include sulfoethyl methacrylate, sulfoethyl acrylate, sulfopropyl methacrylate, sulfopropyl acrylate, styrene sulfonic acid, vinyl sulfonic acid, 2-methacrylamido-2-methyl propanesulfonic acid, and 2-acrylamido-2-methyl propanesulfonic acid, and salts thereof, with 2-acrylamido-2-methyl propanesulfonic acid and sulfoethyl methacrylate being preferred.

Suitable anionic surfactants include sodium dodecylbenzene sulfonate (SDS) or dodecyl allyl sulfosuccinate. It is understood that the term “a first monomer” is used to refer to one or more monomers; similarly, “an aqueous dispersion” refers to one or more aqueous dispersions; thus, a methacrylate monomer refers to one or more methacrylate monomers.

The term “redox initiator system” refers to a combination of a reducing agent, an oxidizing agent, and a metal ion catalyst. Examples of suitable oxidizing agents include persulfates such as ammonium and alkali metal persulfates; hydroperoxides, such as t-butyl hydroperoxide and cumene hydroperoxide; peroxides such as benzoyl peroxide, caprylyl peroxide, and di-t-butyl peroxide; peresters such as t-butyl peracetate, t-butyl perphthalate, and t-butyl perbenzoate; percarbonates; and perphosphates; with t-butyl hydroperoxide being preferred.

Examples of suitable reducing agents include ascorbic acid, isoascorbic acid, malic acid, glycolic acid, oxalic acid, lactic acid, and thioglycolic acid; an alkali metal hydrosulfite such as sodium hydrosulfite; a hyposulfite such as potassium hyposulfite; or a metabisulfite such as potassium metabisulfite; and sodium formaldehyde sulfoxylate.

Suitable accelerators include halide and sulfate salts of cobalt, iron, nickel, and copper, used in small amounts. An example of a preferred redox initiator system is t-butyl hydroperoxide/isoascorbic acid/Fe⁺². Preferably, the accelerator is added prior to the addition of the oxidizing and reducing agents. It is further preferred that the oxidizing and reducing agents are added over time to maintain a relatively even level of radical flux over the course of the addition of monomers.

The dispersion of TiO₂ and the amphoteric polymer are advantageously prepared by slowly adding, with concomitant grinding, the TiO₂ to an aqueous dispersion of the amphoteric polymer. The preferred solids content of the TiO₂/amphoteric polymer dispersion is in the range of 70 to 80 weight percent based on the weight of TiO₂, amphoteric polymer, and water.

To achieve both relatively high gloss and retention of gloss in paint formulations containing the encapsulated pigment polymer, the encapsulating polymer was found to have a T_{g} of not greater than 35° C., preferably not greater than 30° C.; and preferably not less −40° C., more preferably not less than −30° C.

Though not bound by theory, it is believed that the enhanced gloss observed for formulations that include the soft encapsulating polymer is related to the propensity of this polymer to form a film near ambient temperatures. It has also been discovered that formulations of relatively high gloss and retention of gloss can be prepared in the substantial absence of volatile organic solvents, preferably less than 1000 ppm, more preferably less than 100 ppm, and most preferably less than 10 ppm of volatile organic solvents.

The composition of the present invention is useful as a coating, an adhesive, or a sealant for a suitable substrate or primed include metal, plastic, concrete, wood, asphalt, hair, paper, leather, rubber, foam, or textiles.

### Examples

The following examples are for illustrative purposes only and are not intended to limit the scope of the invention.

### ABBREVIATIONS

SDS=Sodium dodecylbenzene sulfonate (23%) BA=Butyl acrylate
SSS=Sodium styrene sulfonate MMA=Methyl methacrylate
BHP=t-Butyl hydroperoxide MAA=Glacial methacrylic acid
EDTA=Ethylene diamine tetraacetic acid ALMA=Allyl methacrylate
IAA=Isoascorbic acid DI water=Deionized water
PEM=phosphoethyl methacrylate SDS=sodium dodecylbenzene sulfonate

### Preparation of Encapsulating Polymer Intermediates

### Intermediate 1

### Preparation of an Aqueous Dispersion of Fully Polymer Encapsulated TiO₂ Particles, T_{g}=5° C.

An aqueous dispersion of fully polymer encapsulated TiO₂ particles (the fully encapsulated composite) was prepared substantially in accordance with the following procedure: To a 500-mL four-necked round bottom flask equipped with paddle stirrer, N₂-inlet, reflux condenser, heating mantel, and thermocouple was charged TiO₂-amphoteric polymer slurry (prepared essentially as described in US Pat. Pub. 20100/298483, Example 1; 197.3 g, 73% solids) along with a solution of SDS (1.5 g) mixed in DI water (10 g) and a separate solution of SSS (1.2 g in 10 g DI water). The flask was purged with N₂, and heated to 50° C., at which time aqueous solutions of 0.1% iron(II) sulfate (4.0 g) and 1% EDTA (0.4 g) were combined and added to the flask. Two minutes later, co-feed #1 (BHP (1.6 g) dissolved in DI water (25 g) and co-feed #2 (IAA (0.9 g) dissolved in DI water (25 g) were fed to the flask at a rate of 0.25 g/min Two minutes after the onset of the co-feed solution addition, a monomer emulsion (ME 1) prepared by mixing DI water (6.0 g), SDS (0.75 g), BA (16.8 g), MMA (11.25 g), MAA (0.29 g) and ALMA (0.14 g) was fed to the reactor at a rate of 2.0 g/min at a temperature of 50° C. When the ME 1 addition was complete, a second monomer emulsion (ME 2) that was prepared previously by mixing DI water (19.0 g), SDS (2.25 g), BA (50.4 g), MMA (33.6 g), and MAA (0.86 g) was fed to the reactor at a rate of 2.0 g minute at 50 C along with the continuation of co-feeds #1 and #2. When ME 2 was complete the co-feed additions were continued for another 20 min until completion. The contents of the reactor were then cooled to room temperature after which time aqua ammonia (1.5 g, 28%) was added. The contents of the reactor were then filtered to remove any gel. The filtered dispersion was found to have a solids content of 61.5% with 0.01 g (˜23 ppm) of dry gel removed.

### Intermediate 2

### Preparation of an Aqueous Dispersion of Fully Polymer Encapsulated TiO₂ Particles, T_{g}=27° C.

An aqueous dispersion of the fully encapsulated composite was prepared substantially in accordance with the following procedure: To a 500-mL four-necked round bottom flask equipped with paddle stirrer, N₂-inlet, reflux condenser, heating mantel, and thermocouple was charged TiO₂-amphoteric polymer slurry (197.3 g, 73% solids) along with a solution of SDS (1.5 g) mixed in DI water (10 g) and a separate solution of SSS (1.2 g in 10 g DI water). The flask was purged with N₂, and heated to 50° C., at which time aqueous solutions of 0.1% iron(II) sulfate (4.0 g) and 1% EDTA (0.4 g) were combined and added to the flask. Two minutes later, co-feed #1 (BHP (1.6 g) dissolved in DI water (25 g) and co-feed #2 (IAA (0.9 g) dissolved in DI water (25 g) were fed to the flask at a rate of 0.25 g/min Two minutes after the onset of the co-feed solutions addition, a monomer emulsion (ME 1) prepared by mixing DI water (6.0 g), SDS (0.75 g), BA (13.0 g), MMA (15.1 g), MAA (0.29 g) and ALMA (0.14 g) was fed to the reactor at a rate of 2.0 g/min at a temperature of 50° C. When the ME 1 addition was complete, a second monomer emulsion (ME 2) that was prepared by mixing DI water (19.0 g), SDS (2.25 g), BA (39.0 g), MMA (44.5 g), and MAA (0.86 g) was fed to the reactor at a rate of 2.0 g minute at 50 C along with the continuation of co-feeds #1 and #2. When ME 2 was complete, the co-feed additions were continued for another 20 min until completion. The contents of the reactor were then cooled to room temperature, after which time aqua ammonia (1.5 g, 28%) was added. The contents of the reactor were then filtered to remove any gel. The filtered dispersion was found to have a solids content of 60.5% with 0.01 g (˜56 ppm) of dry gel removed.

### Intermediate 3

### Preparation of an Aqueous Dispersion of Fully Polymer Encapsulated TiO₂ Particles, T_{g}=42° C.

An aqueous dispersion of the fully encapsulated composite was prepared substantially in accordance with the following procedure: To a 500-mL four-necked round bottom flask equipped with paddle stirrer, N₂-inlet, reflux condenser, heating mantel, and thermocouple was charged TiO₂-amphoteric polymer slurry (197.3 g, 73% solids) along with a solution of SDS (1.5 g) mixed in DI water (10 g) and a separate solution of SSS (1.2 g in 10 g DI water). The flask was purged with N₂, and heated to 50° C., at which time aqueous solutions of 0.1% iron(II) sulfate (4.0 g) and 1% EDTA (0.4 g) were combined and added to the flask. Two minutes later, co-feed #1 (BHP (1.6 g) dissolved in DI water (25 g) and co-feed #2 (IAA (0.9 g) dissolved in DI water (25 g) were fed to the flask at a rate of 0.25 g/min Two minutes after the onset of the co-feed solution addition, a monomer emulsion (ME 1) prepared by mixing DI water (6.0 g), SDS (0.75 g), BA (12.8 g), MMA (15.4 g), MAA (0.14 g) and ALMA (0.14 g) was fed to the reactor at a rate of 2.0 g/min at a temperature of 50° C. When the ME 1 addition was complete, a second monomer emulsion (ME 2) that was prepared by mixing DI water (19.0 g), SDS (2.25 g), BA (29.9 g), MMA (46.6 g), AAEM (6.4 g) and MAA (2.7 g) was fed to the reactor at a rate of 2.0 g minute at 50° C. along with the continuation of co-feeds #1 and #2. When ME 2 was complete, the co-feed additions were continued for another 20 min until completion. The contents of the reactor were then cooled to room temperature, after which time aqua ammonia (2.5 g, 28%) was added. The contents of the reactor were then filtered to remove any gel. The filtered dispersion was found to have a solids content of 60.5% with 0.01 g (˜51 ppm) of dry gel removed.

Differential Scanning calorimetry

T_{g}s for the encapsulating polymers of Intermediates 1-3 were determined using differential scanning calorimetry (DSC) as follows: The samples were dried overnight in an oven at 60° C. before T_{g} measurement by temperature-modulated DSC. The temperature of each sample was ramped to 150° C. at a heating rate of 20 C.°/min, and equilibrated at 150° C. for 5 min. The T_{g}s were taken as the inflection point of the second heating scan from −90° C. to 200° C. at a heating rate of 7 C.°/min. The degree of modulation was set at ±1 C.°, every 40 s.

### Paint Formulations

A typical industrial paint formulation containing TiO₂ pigments and polyurethane dispersions was used in this study. The solid content of the encapsulating polymer dispersion was typically from 59-61%.

The gloss values were obtained according to ASTM D523-89(1999) Standard Test Method for Specular Gloss. Drawdowns over chromate pre-treated aluminum panels were prepared using 10-mil Dow Latex Film Applicator, and allowed to dry in the constant temperature room. The gloss measurement was performed using micro-TRI-gloss meter from BYK Gardner after 1 day, 7 days, and 1 month on the same drawdowns. Each value reported here is an average over three measurements on different positions of the same drawdown on the same date.

The description of the paint formulations including PVC, T_{g} of the encapsulating polymer, and component amounts by weight percent are shown in Tables 1 and 2. C1-C9 refer to Comparative Examples 1-9; Encapsulating Polymer refers to Intermediates 1, 2, or 3, as evident by the T_{g}; Acrylic Polymer 1 is RHOPLEX™ VSR-2015 Acrylic Emulsion Polymer; Acrylic Polymer 2 is RHOPLEX™ AC-261LE Acrylic Emulsion Polymer; Acrylic Polymer 3 is RHOPLEX™ HG-98B Acrylic Emulsion Polymer; PUD is Sancure 815 Aliphatic Waterborne Polyurethane Dispersion; Defoamer is Foamex 1488 Defoamer; TiO₂ is Ti-Pure R-746 TiO₂; Coalescent is Texanol ester alcohol; RM1 is ACRYSOL™ RM-2020NPR Rheology Modifier; and RM2 is ACRYSOL™ RM-8W Rheology Modifier. (RHOPLEX and ACRYSOL are Trademarks of The Dow Chemical Company or Its Affiliates.)

TABLE 1
Paint Formulations

| | Example # | | | | | | | |
|---|---|---|---|---|---|---|---|---|
| | 1 | 2 | 3 | C1 | C2 | C3 | C4 | C5 |
| PVC | 17 | 19 | 8 | 17 | 19 | 20 | 20 | 8 |
| T_{g} (° C.) | 5 | 27 | 5 | | | | 42 | 42 |
| Intermediate 1 | 67.44 | | 33.59 | | | | | |
| Intermediate 2 | | 67.85 | | | | | | |
| Intermediate 3 | | | | | | | 71.17 | 30.62 |
| Acrylic Polymer 1 | | | 27.75 | 39.28 | | | | |
| Acrylic Polymer 2 | | | | | 38.04 | | | |
| Acrylic Polymer 3 | | | | | | 41.83 | | 28.35 |
| PUD | 24.03 | 23.26 | 28.96 | 24.05 | 23.29 | 23.05 | 23.02 | 33.47 |
| Defoamer | 0.20 | 0.20 | 0.09 | 0.20 | 0.20 | 0.18 | 0.09 | 0.08 |
| TiO₂ | | | | 27.05 | 29.05 | 30.29 | | |
| NaNO₃ (15%) | 0.87 | 0.86 | 1.08 | 0.87 | 0.86 | 0.85 | 0.85 | 0.88 |
| Coalescent | | | | | | 2.23 | 2.23 | 2.74 |
| RM1 | 0.91 | 0.89 | 1.22 | 0.91 | 0.90 | 0.76 | 0.76 | 0.92 |
| RM2 | 0.31 | 0.30 | 0.65 | 0.31 | 0.30 | 0.19 | 0.19 | 0.48 |
| Water | 6.34 | 6.74 | 6.66 | 7.33 | 7.38 | 0.61 | 1.70 | 2.46 |
| Totals | 100 | 100 | 100 | 100 | 100 | 100 | 100 | 100 |

TABLE 2
Paint Formulations

| | Example # | | | | | | | | | |
|---|---|---|---|---|---|---|---|---|---|---|
| | 4 | C6 | 5 | C7 | 1 | C1 | 6 | C8 | 7 | C9 |
| PVC | 21 | 21 | 19 | 19 | 17 | 17 | 15 | 15 | 13 | 13 |
| T_{g} (° C.) | 5 | | 5 | | 5 | | 5 | | 5 | |
| Intermediate 1 | 52.90 | | 60.49 | | 67.44 | | 73.71 | | 79.50 | |
| Acrylic | | 30.84 | | 35.27 | | 39.28 | | 42.99 | | 46.38 |
| Polymer 1 | | | | | | | | | | |
| PUD | 43.99 | 44.05 | 33.53 | 33.59 | 24.03 | 24.05 | 15.32 | 15.35 | 7.34 | 7.36 |
| Defoamer | 0.20 | 0.20 | 0.20 | 0.20 | 0.20 | 0.20 | 0.19 | 0.20 | 0.19 | 0.18 |
| TiO₂ | | 21.20 | | 24.24 | | 27.05 | | 29.55 | | 31.88 |
| NaNO₃ (15%) | 0.90 | 0.90 | 0.88 | 0.89 | 0.87 | 0.87 | 0.86 | 0.86 | 0.85 | 0.85 |
| RM1 | 0.94 | 0.94 | 0.92 | 0.93 | 0.91 | 0.91 | 0.90 | 0.90 | 0.88 | 0.89 |
| RM2 | 0.32 | 0.32 | 0.31 | 0.31 | 0.31 | 0.31 | 0.30 | 0.30 | 0.30 | 0.30 |
| Water | 0.75 | 1.55 | 3.66 | 4.58 | 6.34 | 7.33 | 8.72 | 9.85 | 10.94 | 12.16 |
| Totals | 100 | 100 | 100 | 100 | 100 | 100 | 100 | 100 | 100 | 100 |

Table 3 illustrates gloss and gloss retention for paints formulated using polyurethane dispersions (PUDs) and dispersions of TiO₂ that are either: a) unencapsulated (Comp. Examples 1-3); or b) encapsulated and with an acrylic polymer (Comp. Example 4 and Examples 1 and 2). The PUD was Sancure 815 Waterborne Urethane Polymer Dispersion; the weight-to-weight ratio of acrylic solids to PUD solids was 70:30; the coalescent was Texanol ester alcohol; and “NA” means not applicable (since C1-C3 were prepared without encapsulation of TiO₂).

TABLE 3
Gloss and Gloss Retention for Polymer Encapsulated and Unencapsulated TiO₂
Particles

| | Coalescent | | | 20° Gloss | | | 60° Gloss | | |
|---|---|---|---|---|---|---|---|---|---|
| Ex # | level (%) | PVC | T_{g} ° C. | 1-day | 7-day | 1-mo | 1-day | 7-day | 1-mo |
| C1 | 0 | 17 | NA | 24.1 | 20.9 | 20.5 | 62.8 | 60.2 | 59.9 |
| C2 | 0 | 19 | NA | 28.1 | 26.9 | 25.5 | 65.5 | 64.5 | 62.9 |
| C3 | 8.3 | 20 | NA | 23 | 18.6 | 17.1 | 60.5 | 56.8 | 55.2 |
| C4 | 8.3 | 20 | 42 | 22.2 | 23.5 | 23.4 | 56.1 | 57.3 | 57.5 |
| 1 | 0 | 17 | 5 | 42.5 | 43.4 | 43.4 | 71.3 | 72.0 | 72.0 |
| 2 | 0 | 19 | 27 | 43.6 | 44.0 | 44.4 | 71.0 | 70.9 | 70.8 |

The data from Table 3 show that both 20° and 60° gloss is markedly lower for the comparative examples C1 to C4; for the formulations containing unencapsulated TiO₂ (C1 to C3), the gloss drifts downward; Comparative Example 4, which includes pigment particles encapsulated with above ambient temperature T_{g} encapsulating polymer. Only the formulations with pigment particles encapsulated with the softer encapsulating polymer (ambient temperature or below) show both high gloss and retained gloss.

Table 4 illustrates gloss improvement for a low T_{g} encapsulating polymer with respect to a high T_{g} encapsulating polymer at low PVC.

TABLE 4
Gloss and Gloss Retention for a low PVC Composition

| | Coalescent | | | 20° Gloss | | | 60° Gloss | | |
|---|---|---|---|---|---|---|---|---|---|
| Ex # | level (%) | PVC | T_{g} ° C. | 1-day | 7-day | 1-mo | 1-day | 7-day | 1-mo |
| C5 | 8.3 | 8 | 42 | 42.4 | 43.2 | 43.2 | 71.5 | 71.9 | 71.9 |
| 3 | 0 | 8 | 5 | 57.3 | 57.3 | 57.7 | 79.2 | 79.4 | 79.3 |

The formulation of Comparative Example 5 (C5), which uses the high T_{g} polymer encapsulated TiO₂, shows a reduced gloss as compared to the formulation of Example 3, which shows improved gloss over the comparative example.

Table 5 illustrates the effect of Acrylic:PUD weight-to-weight ratio on gloss and gloss retention. T_{g} for the encapsulating polymer was 5° C. Comparative examples C1, and C6-C9 are unencapsulated TiO₂.

TABLE 5
Effect of Acrylic:PUD ratio on Gloss and Gloss Retention

| | Acrylic/ | | | | | | | |
|---|---|---|---|---|---|---|---|---|
| | PUD | | | | | | | |
| Ex | Blend | | 20° Gloss | | | 60° Gloss | | |
| # | Ratio | PVC | 1-day | 7-day | 1-mon | 1-day | 7-day | 1-mon |
| C6 | 90:10 | 21 | 14.6 | 13.5 | 14.0 | 55.3 | 54.2 | 54.5 |
| 4 | 90:10 | 21 | 34.2 | 35.2 | 36.2 | 66.3 | 66.9 | 67.3 |
| C7 | 80:20 | 19 | 16.6 | 14.7 | 14.0 | 56.5 | 54.8 | 53.9 |
| 5 | 80:20 | 19 | 39.8 | 40.1 | 40.4 | 69.1 | 69.6 | 69.7 |
| C1 | 70:30 | 17 | 24.1 | 20.9 | 20.5 | 62.8 | 60.2 | 59.9 |
| 1 | 70:30 | 17 | 42.5 | 43.4 | 43.4 | 71.3 | 72.0 | 72.0 |
| C8 | 60:40 | 15 | 32.2 | 30.3 | 29.2 | 67.6 | 66.4 | 65.6 |
| 6 | 60:40 | 15 | 49.8 | 50.4 | 50.3 | 75.6 | 76.0 | 75.8 |
| C9 | 50:50 | 13 | 42.0 | 39.5 | 39.0 | 73.0 | 71.8 | 71.1 |
| 7 | 50:50 | 13 | 54.5 | 53.8 | 53.4 | 78.7 | 78.3 | 77.9 |

The data show gloss retention and gloss improvement over unencapsulated TiO₂ through a broad range of acrylic:PUD.

1. A composition comprising a stable aqueous dispersion of polyurethane particles and pigment particles partially or fully encapsulated with a soft polymer having a T_{g} not higher than 35° C.; wherein the weight percent of the polyurethane particles, based on the weight of the polyurethane particles and the soft polymer, is such that the pigment volume concentration of the composition is in the range of 6 to 25.

2. The composition of claim 1 wherein the weight percent of polyurethane particles is from 10 to 70 weight percent, based on the weight of the polyurethane particles and the soft polymer, the pigment particles are fully encapsulated with the soft polymer having a shell thickness in the range of from 10 nm to 90 nm and a T_{g} of not greater than 30° C.

3. The composition of claim 1 wherein the soft polymer is an acrylic, styrene-acrylic, or vinyl acrylic polymer.

4. The composition of claim 1 wherein the weight percent of polyurethane particles is from 20 to 50 weight percent, based on the weight of the polyurethane particles and the soft polymer.

5. The composition of claim 4 wherein the soft encapsulating polymer is an acrylic or styrene acrylic copolymer than contains structural units of a) methyl methacrylate or styrene; b) butyl acrylate and c) sodium styrene sulfonate.

6. The composition of claim 5 which is substantially free of volatile organic solvents.
